(19) United States
(12) Patent Application Publication
(10) Pub. No.: US 2003/0224730 A1
(43) Pub. Date: Dec. 4, 2003

(54) Method and apparatus for selection of downlink carriers in a cellular system using multiple downlink carriers

(76) Inventors: Peter Muszynski, Espoo (FI); Uwe Schwarz, Veikkola (FI); Harri Holma, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/379,529

(22) Filed: Mar. 6, 2003

Related U.S. Application Data
(60) Provisional application No. 60/375,837, filed on Apr. 29, 2002.

(51) Int. Cl. H04B 7/00

(52) U.S. Cl. 455/62; 455/72

(57) ABSTRACT

A method and apparatus for selection of downlink carriers in a cellular system that includes selecting a first downlink carrier for use by a mobile node. A decision is made that the mobile node should use another downlink carrier. The mobile node is then directed by a network node to use a second downlink carrier. The first downlink carrier and second downlink carrier may be from different cells or the same cell supplying downlink frequencies. The network node may decide that the mobile node should use another downlink carrier based on several factors such as current load conditions of the cells supplying the first downlink carrier and the second downlink carrier, a type of service on the current downlink carrier, whether the mobile node has connection capability at frequencies of the second downlink carrier, or if a potential interference condition may exist.

This application claims the benefit of U.S. Provisional Patent Application Ser. No. 60/375,837 filed Apr. 29, 2002, the contents of which is expressly incorporated by reference herein in its entirety.

### BACKGROUND

1. Field of the Invention

This invention relates to cellular systems, and more specifically to downlink carriers in cellular systems.

2. Background Information

In current cellular networks, such as universal mobile telecommunication systems terrestrial radio access networks (UTRAN) (e.g., Global System for Mobile Communications (GSM), Code Division Multiple Access 2000 (CDMA2000), Wideband CDMA (WCDMA), etc.) a pair of frequencies is used, one for the uplink (UL) channel and one for the downlink (DL) channel. Therefore, there is always a one-to-one correspondence between the two. However, whenever new spectrum becomes available, for example, from the 2.5 GHz extension band, rationale needs to exist for which of the multiple choices for the DL carrier should be selected to be associated with the one UL carrier.

### SUMMARY OF THE INVENTION

The present invention relates to a method and apparatus for selection of downlink carriers in a cellular system that includes: selecting a first downlink carrier for use by a mobile node, deciding that the mobile node should use another downlink carrier, directing the mobile node to use a second downlink carrier where the directing being from a network node, and using the second downlink carrier by the mobile node. The first downlink carrier may be selected from a first cell and the second downlink carrier from a second cell, or the first downlink carrier and the second downlink carrier may be selected from the same cell. The first cell may include downlink carriers in a core band and the second cell downlink carriers in an extension band.

The network node may decide that the mobile node should use another downlink carrier based on several factors such as current load conditions of the cells supplying the first downlink carrier and the second downlink carrier, a type of service on the current downlink carrier, whether the mobile node has connection capability at frequencies of the second downlink carrier, or if a potential interference condition may exist.

The present invention is also related to a network node containing instructions stored therein where the instructions when executed cause the network node to perform: selecting a downlink carrier for use by a mobile node, deciding that the mobile node should use another downlink carrier, and directing the mobile node to use a second downlink carrier.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A and 1B are diagrams of uplink and downlink carrier pairings according to example embodiments of the present invention;

FIG. 2 is a diagram of frequencies and bands they are associated with according to an example embodiment of the present invention;

FIG. 3 is a diagram of load-based selection according to an example embodiment of the present invention;

FIG. 4 is a diagram of switching based on real-time (RT) and non real-time (NRT) loading according to an example embodiment of the present invention;

FIG. 5 is a table of type of service versus preferred system according to an example embodiment of the present invention;

FIG. 6 is a diagram of a potential interface scenario in an uplink channel according to an example embodiment of the present invention; and

FIG. 7 is a diagram of mobile node measurement activities during different mobile node states according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to method and apparatus for selection of downlink (DL) carriers in a cellular system when multiple DL carriers are available. Selection of downlink carriers may occur where a second downlink carrier is selected from one cell to replace a downlink carrier currently being used in another cell. Further, selection of downlink carriers may occur where a second downlink carrier is selected from a cell to replace a downlink carrier currently being used in the same cell. A cell typically supplies a band of frequencies that may be used for uplink carriers or downlink carriers. The present invention may be implemented in any cellular system regardless of the technology used. To illustrate the present invention, embodiments will be used where the present invention is used in a WCDMA system, however, the present invention is not limited to use in a WCDMA system or use of the associated WCDMA specific terms and/or features.

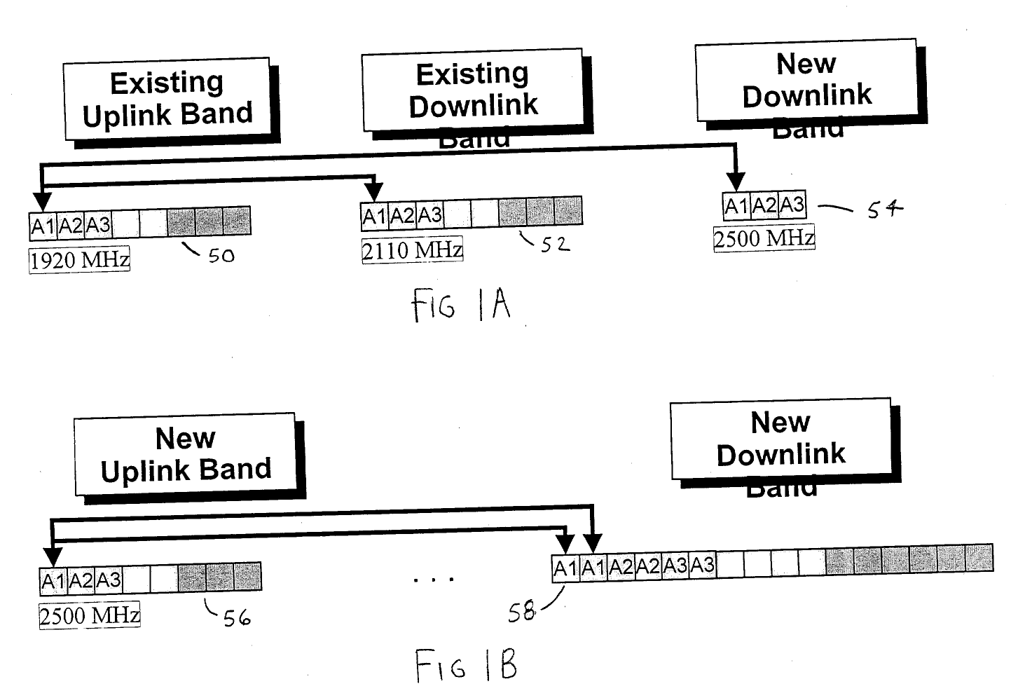

FIGS. 1A and 1B show diagrams of uplink and downlink carrier pairings according to example embodiments of the present invention. Uplink and downlink carriers from the existing band generally may be frequencies supplied by the same cell, but may be supplied from different cells. Similarly, uplink and downlink carriers from the new band may be frequencies supplied from the same cell (different from the cell supplying existing band frequencies). The A1, A2, A3, . . . represent different uplink/downlink frequency pairings. The frequencies in the box for each band starting with “A”, may be controlled by one operator at the cell, the frequencies in the blank boxes controlled by a second operator at the cell, and the frequencies in the darkened boxes controlled by a third operator at the cell.

In these example embodiments, the existing uplink frequency band is shown to include frequencies starting at approximately 1920 MHz, the existing downlink band to include frequencies starting at approximately 2110 MHz, and the new uplink and downlink bands to include frequencies starting at approximately 2500 MHz. However, the present invention is not limited by these frequency values but may be applied to any bands of possible frequencies. The frequencies being shown in FIGS. 1A and 1B here are for illustration purposes only.

FIG. 1A shows an example embodiment where a mobile node may be connected with a uplink carrier frequency from an existing uplink band 50 and a downlink carrier frequency from an existing downlink band 52. The existing downlink carrier band 52 may be a core band from a cell closest to the location of the mobile node. A network node may determine that the mobile node should select a second downlink carrier, and direct the mobile node to start using a downlink carrier from frequencies in a new or different downlink band 54 (i.e., from a different cell). The mobile node may then use the uplink carrier from the existing band 50 and a downlink carrier from a new or different downlink band 54.

FIG. 1B shows an example embodiment where a mobile node may have originally been using an uplink carrier from a new uplink band 56 and a downlink carrier from a new downlink band 58. The new uplink band and new downlink band may be from the same band of frequencies (e.g., starting at approximately 2500 MHz where some frequencies are used for uplink carriers and some for downlink carriers). In this example embodiment, a network node may direct the mobile device to switch over and use a different downlink carrier, but from the same band of frequencies as the original downlink carrier. The frequencies in the new uplink band and the new downlink band may be supplied by the same cell, or from different cells.

Therefore in methods and apparatus for selection of downlink carriers in a cellular system according to the present invention, downlink carriers may be selected for use from a different band of frequencies than the original downlink carrier, or from the same band of frequencies as the original downlink carrier. Moreover, a network node may direct a mobile device to use a different downlink carrier, or the mobile device may decide on its own when to switch to a different downlink carrier. Criteria used to determine selection will be discussed later.

The present invention will now be illustrated as it may be applied in a WCDMA system. However, as noted previously, the present invention may be applied to any cellular system and is not limited to use in this type of cellular system. WCDMA is an example UTRAN network. UTRAN has evolved into where in addition to the current UL-DL pairing within the current 3G core bands, additional carriers within an extension band (here 2.5 GHz bands but not limited to those) may be used for DL only operation. Radio connections pertaining to one particular core band UL carrier may be carried on more than one DL carrier, however, each radio link may use at most one carrier (either in core or in 2.5 GHz band) at each point in time. Further, variable duplexing in the mobile device (i.e., UE) may be used to access the additional carriers in the 2.5 GHz bands. The terms mobile device, UE, and mobile node may be used interchangeably in illustrating operation and embodiments of the present invention.

A mobile device connected to a cellular communications network may base its choice on selection of a DL carrier on any of several factors such as, e.g., load condition, interference condition, service, and the capability of the mobile device. Some mobile devices may not be capable of using additional DL carriers, e.g., additional carriers available in the 2.5 GHz band. Moreover, selection of a DL carrier by a mobile device may occur while the mobile device is in different modes or conditions.

A mobile node may select a DL carrier while in an idle mode, during requesting of a Radio Resource Control (RRC) connection. Initially, the UE selects the UL-DL carriers (within the core band, i.e., 2.0 GHz) according to the cell selection criteria of nowadays UTRAN. During establishment of a RRC connection, the Network (i.e., a network node in the network) directs (via RRC signaling) the mobile node (i.e., user equipment (UE)) to use a particular DL carrier (eg from the 2.5 GHz extension band) with the currently used UL carrier, or possibly also, with another UL carrier. This decision could be based on considering e.g., UE capabilities, UL/DL load situation of the system, interference indication, etc. The UE may then continue in cell_FACH/cell_PCH state with this modified UL-DL pairing. Also UE may enter cell_DCH state with this pairing.

Further, the mobile node may be in a start-up state or during a cell_FACH state, when the mobile node or user equipment is requesting a DCH connection. Initially, the UE selects the UL-DL carriers (within the coreband) according to the cell selection criteria of nowadays UTRAN. During cell_FACH state, when the UE request a DCH connection, the Network may direct (via RRC signaling) the UE to use a particular DL carrier (e.g., from the 2.5 GHz extension band) with the currently used UL carrier, or possibly also, with another UL carrier. This decision could be based on considering, e.g., the UE capabilities, UL/DL load situation of the system, interference indication, etc. The UE may then enter the cell_DCH state with this modified UL-DL pairing.

In addition, the mobile node may be in a power-on or idle mode cell reselection state. In this state, when selecting cells, the mobile node may measure the quality of DL carriers from the core band as well as from the 2.5 GHz extension band. If in a certain geographical area core band and the 2.5 GHz extension band are both available, information may be broadcasted on the BCHs of the DL carriers where the UE should preferably camp and which UL carriers should be used for the 2.5 GHz DL carriers (this could be done considering, e.g., UE capabilities, UL/DL load situation of the system, etc). Based on the common pilot channel (CPICH) radio quality in own, and other bands (e.g., UL interference due to adjacent channel interference or SHO areas in UL but not in DL carriers) and this preference information, the UE may camp on the preferred UL-DL pairing and inform the network accordingly (e.g., suitable via RRC connection setup, cell update procedures).

Radio connections pertaining to one particular core band UL carrier may be carried on more than one DL carrier. However, each radio link may use only one DL carrier (either in the core band or the 2.5 GHz band) at each point and time. Variable duplexing in the mobile device may be used to access the additional carriers in the 2.5 GHz bands.

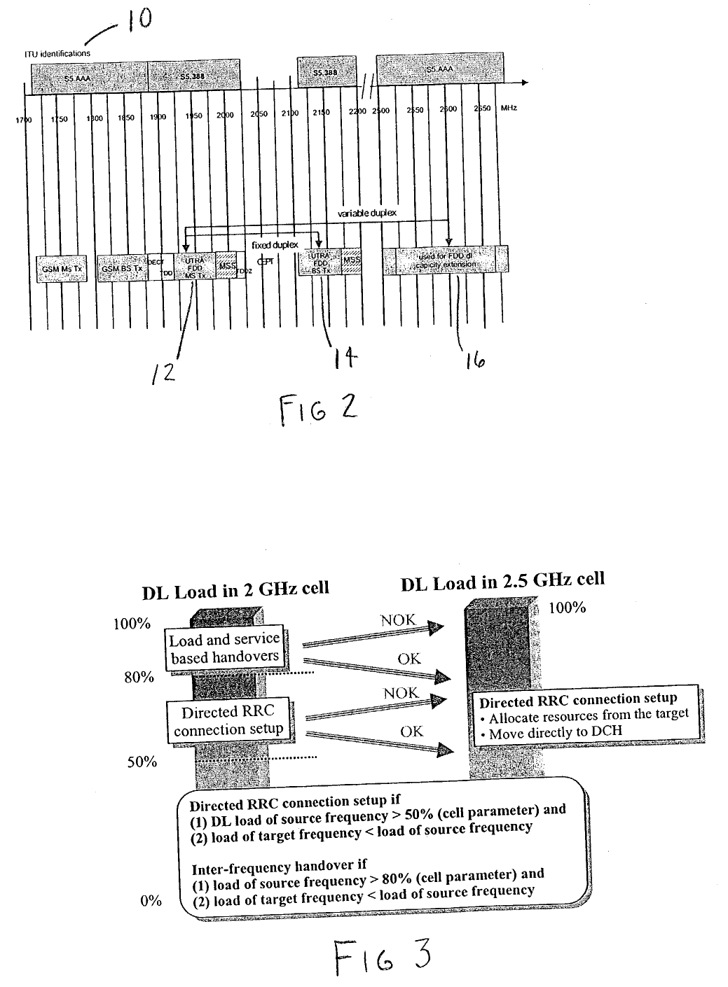

FIG. 2 shows a diagram of frequencies and bands they are associated with according to an example embodiment of the present invention. The boxes 10 at the top of FIG. 2 show the ITU identifications for the bands of frequencies. One box 12 shows the UTRAFDD band of frequencies for the mobile station (MS). An UTRAFDD box 14 shows the core band of frequencies that extend from approximately 2100 MHz through 2175 MHz. Further, the 2.5 GHz band of frequencies is shown by a box 16 and extends from approximately 2500 MHz through 2575 MHz. According to the present invention, a mobile device currently using a DL in the frequency band shown in the UTRAFDD box 14, may select to use a different DL frequency from one of the frequencies shown in the box 16.

According to the present invention, multiple DL carriers may be associated with one UL carrier. In a case like this, where multiple DL carriers need to be associated with one UL carrier, a rational choice needs obviously to be made as which of the multiple choices for the DL carrier should be selected.

FIG. 3 shows a diagram of load-based selection according to an example embodiment of the present invention. Selection of a different DL carrier is shown for two different states of the mobile device, when the mobile device is in a directed radio resource control (RRC) connection setup state, and when the mobile device is in a state already having an RRC connection and is attempting an inter-frequency handover. The columns shown on the left show the DL load at the mobile device on a frequency using the core 2 GHz band cell. The column on the right shows the DL load on a frequency at a 2.5 GHz cell. The arrows show the situations when selection of a new DL carrier in the 2.5 GHz cell is appropriate (OK) and inappropriate (NOK).

When the mobile device is in the directed RRC connection setup state, a DL carrier from the 2.5 GHz cell may be selected only if the DL load of the source frequency (i.e., at the core 2 GHz) is larger than 50% of the maximum load for the cell and the load of the target frequency (2.5 GHz cell) is less than the load of the source frequency.

Regarding the mobile device during an inter-frequency handover, the mobile device may select a DL carrier from the 2.5 GHz cell if the load of the source frequency is larger than 80% of the maximum load for the cell and the load of the target frequency is less than the load of the source frequency.

The percentages used in FIG. 3, i.e., 50% and 80%, are used for illustrative purposes only and may be other values and still be within the limitations of the present application. These percentages may be set by the network and used to determine whether another DL carrier should be selected for the given mobile device. A network device, e.g., radio network controller (RNC) base station controller (BSC), etc. monitors the loading at the various cells such as the source and target cells, and makes a determination based on loading whether the DL carrier for a particular mobile device should be switched to another DL carrier. Switching to another DL carrier while the mobile node is in a state of directed RRC connection setup may be preferred over switching while the mobile node is in a state of inter-frequency handover because while the mobile node is in the directed RRC connection setup state, the mobile node may not need to make target frequency measurements beforehand. Depending on mobility of the services in the 2.5 GHz band, load balancing may be the main traffic balancing feature and would not require compressed mode (CM) measurements as opposed to inter-band handovers. A purely load balancing feature could be extended also to a service direction feature using the given service priority table in the Radio Network Controller (RNC).

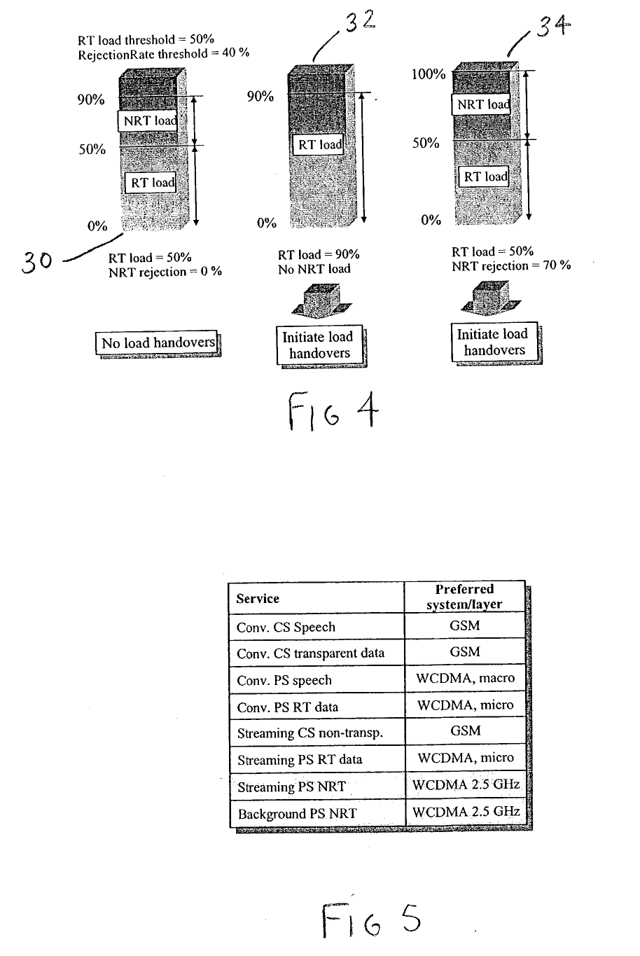

FIG. 4 shows a diagram of switching based on real-time (RT) and non realtime (NRT) loading according to an example embodiment of the present invention. Real-time quality of service load relates to services where packets may not exceed a certain delay such as, for example, speech, video, etc. Non real-time quality of service load relates to packets carrying information that may not be as time sensitive such as, for example, Internet traffic, email, etc. The three columns, 30, 32 and 34, represent three carriers and depict different mixes of loading between real-time load and non real-time load at a cell. The first column 30 represents a situation where the real-time load on a downlink carrier is equal to 50% of the maximum allowable load and a non real-time load rejection is equal to 0%. The second column 32 represents a situation where the real-time load on a downlink carrier is equal to 90% of its capacity and there is no non real-time load. Finally, a third column 34 represents a situation where the real-time load is equal to 50% of the maximum load allowable, and the non real-time load rejection is equal to 70%.

A network device on the network may set the real-time load thresholds and rejection rate thresholds for individual cells. The network device may monitor the loading at these cells and if the thresholds have been exceeded, may initiate a handover to another DL carrier at a different cell. In this example embodiment, for all three cells, the real-time load threshold has been set equal to 50% and the rejection rate threshold set equal to 40%. Therefore, if the real-time load exceeds 50% of the maximum loading at a cell, a handover to another DL carrier in another cell may be initiated. Further, if the non real-time load rejection rate rises above 40%, a handover to another DL carrier may be initiated.

In this example embodiment, in the first cell 30 where the real-time load is equal to 50% and the non real-time load rejection is equal to 0%, no inter-frequency handover will occur. However, in the second cell 32, where the real-time load is equal to 90% and there is no non real-time load, an inter-frequency load handover may be initiated since the real-time load has exceeded the 50% threshold. Finally, in the third cell 34 where the real-time load is equal to 50%, normally an inter-frequency load handover will not occur, but since the non real-time load rejection is equal to 70% (higher than the 40% threshold), an inter-frequency load handover may be initiated.

Regarding service reason handover, no service reason handover may be needed if the source system and the target system are symmetric in the sense of having the same capabilities and properties. Core band and 2.5 GHz band however are not exactly symmetric because UEs in the upper band: make more hard handovers (less continuous coverage), need more often and continuous CM, and experience stronger DL attenuation. At least the delays coming from hard handovers (HHOs) and the impact of CM if it is not higher layer scheduling (only for NRT) suggest that it may be preferable to have NRT services in the upper band.

Service reason handover may be implemented by extending the existing priority table in the RNC. The service priority table indicates whether an initiated or currently served call is in its preferred layer. If not, an inter-band handover may be initiated either already at the call initiation phase or later during the call (periodical and clockwise).

In addition to the pure service reason handover, the priority table may also be used for load reason handovers by combining them with service priority. When a handover is due to load, the RNC still has the freedom to choose among the currently served users which of them to hand over. The RNC may then choose those services that are not in their preferred layer.

FIG. 5 shows a table of type of service versus preferred system according to an example embodiment of the present invention. As can be seen, it may be preferred that various types of services or information being transferred on a DL carrier be sent over a particular system or layer. In the example of FIG. 5, the 2.5 GHz band is the preferred layer (operator definable) only for NRT PS services. Therefore, according to the present invention, a network node may direct, for example, all streaming PS non real-time load data to a DL carrier in a 2.5 GHz cell. Thus, the network node may use the type of service as another parameter to determine whether selection of another DL carrier should occur.

Another reason for handover may be because the mobile device has reached the end of coverage of a frequency carrier in the 2.5 GHz band. The end of 2.5 GHz coverage may invoke inter-band, inter-frequency or inter-system handover. The trigger criteria may always be the same. As inter-band handovers can possibly be done faster, separate trigger thresholds might be implemented. Some example coverage triggers for example implementations according to the present invention may include but are not limited to: handover due to Uplink DCH quality, handover due to UE Tx power, handover due to Downlink DPCH power, handover due to common pilot channel (CPICH) received signal chip power (RSCP), and handover due to CPICH chip energy/total noise (Ec/No).

Coverage may be another reason for handover. A coverage handover may occur if: (1) the 2.5 GHz cell has a smaller coverage area (=lower CPICH power or different coverage triggers) than 2 GHz, (2) currently used 2 GHz coverage ends (then also 2.5 GHz), or (3) the UE enters a dead zone.

Further, a dead zone in the core band due to adjacent cell interference (ACI) may not be a dead zone in the extension band because the adjacent carrier in the 2.5 GHz band might not be used in the same geographical area. For (1) an inter-band handover may be best, whereas (2) and (3) may demand an inter-frequency handover. To solve (2) and (3), either only inter-frequency handovers are initiated due to coverage reason or penalty timers prevent ping-pong. However, the number of coverage reason handovers may be limited (except for (1)) due to the anticipated inter-band handover before entering a SHO area. For green fielders getting for the first time a WCDMA frequency in the time division duplex (TDD)/2.5 GHz bands, the end of the 2.5 GHz coverage may mean an inter-frequency or inter-system handover to a roaming partner's network.

Another type of handover may be a blind handover. Blind handover may be an alternative to inter-band measurements (CM). It can be used to decrease the amount of CM measurements and thus the impact of CM to network performance. As 2.5 GHz DL bands may be associated to core DL bands with congruent DL coverage (basic assumption), blind handover is possible in both directions. No CM measurements are needed and there is no delay between handover trigger and handover command but a longer service gap that can be noticed in RT services. Further, a blind handover is suitable for NRT services.

If the UE is informed about the chip synchronization and possibly also the system frame number (SFN) of the target cell, the service gap can be minimized and blind inter-band handover may become an even faster hard handover than current 3GPP inter-frequency handover both in terms of handover delay (trigger→command) and service gap (last transmission time interval (TTI) in band1→first TTI in band2). The reason for this is because: cell search is not needed due to chip synchronization, level measurements (Ec/Io) are known from co-siting, SFN decoding is skipped, and the radio access channel (RACH) or power control preamble is minimized, thus comparable path losses.

The needed information in the measurements control to inform the UE about synchronization may require a change in 3GPP and may also be used for fast CM measurements.

Intra-frequency measurements may be another reason for soft handover. A soft handover procedure in 2.5 GHz may work in principle the same way as in core bands with branch addition, replacement and deletion procedures. SHO procedures may be based on CPICH Ec/I0 measurements. Despite stronger attenuation in the 2.5 GHz band, Ec/I0 as a ratio may be about the same for both bands. Therefore, in principle the same SHO parameter settings may be used in the 2.5 GHz band. However, if stronger attenuation in 2.5 GHz is not compensated for by additional power allocation, the reliability of SHO measurements (Ec/Io) may suffer. Moreover, a 2.5 GHz cell might have neighbors on 2.5 GHz and on 2 GHz at the same time. Then, the UE may have to measure both intra-frequency and inter-band neighbors.

UL interference in the core bands due to delayed soft HO at the 2.5 GHz coverage edge may occur. A 2.5 GHz cell may have both 2.5 GHz neighbors and 2 GHz neighbors at the same time. While for the 2.5 GHz neighbor the normal SHO procedure may be sufficient, for the 2 GHz neighbor an early enough inter-band handover may have to be performed. Otherwise, serious UL interference could occur in the 2 GHz neighbor cell. SHO areas might be located relatively close to the base station and thus not necessarily relate to high UE Tx (transmit) power (or base transceiver station (BTS) Tx power). Coverage handover triggers may not be sufficient.

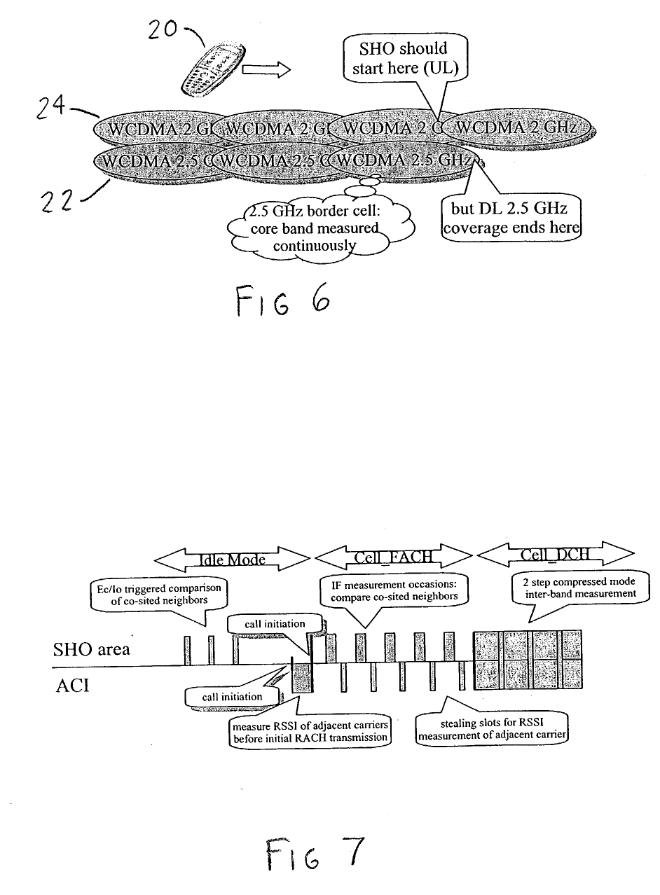

FIG. 6 shows a diagram of the potential interface scenario in an uplink channel according to an example embodiment of the present invention. Four Wideband Code Division Multiple Access (WCDMA) 2 GHz cells 24 are shown with slight intersection between adjacent cell coverage. Similarly, three WCDMA 2.5 GHz cells 22 are shown with slight overlap in coverage area. As a mobile device (UE) 20 moves and approaches cell coverage overlap areas, the mobile device uses UL and DL carriers from neighboring cells. Generally, if the mobile device 20 is using an UL and DL carrier in a 2.5 GHz cell, once the mobile device 20 moves towards the coverage of a neighbor 2.5 GHz cell, a soft handover will occur between the DL and UL carriers of the neighbor cells. However, in a situation where there is no adjacent 2.5 GHz cell as shown here, a soft handover cannot occur since the mobile device 20 must now obtain a DL and UL carrier from a 2 GHz cell. This may cause interference in the UL carrier (not shown). However, according to the present invention, a network device may monitor this situation and cause selection of a different DL carrier early to allow a soft handover from the 2.5 GHz cell to the 2.0 GHz cell, therefore, avoiding potential interference in the UL carrier. Thus, avoiding interference may be another criteria used to determine selection of a different DL carrier.

In order to prevent a directed setup into an interfering area, the UE may need to report in the RACH message the measured neighbors in the core band. The message attachment may be standardized but needs to be activated. RNC then must check that all measured cells have a co-sited neighbor in 2.5 GHz.

Adjacent cell interference (ACI) detection before the directed setup is automatically given if FACH decoding in the core band was successful. Load reason handover may be needed in addition to Directed RRC connection setup for congestion due to mobility. The load reason handover in current implementations is initiated by UL and DL specific triggers. By setting the trigger thresholds the operator can steer the load balancing:

for load threshold for RT users, in UL the total received power by the BTS relative to the target received power (PrxTarget) and in DL the total transmitted power of the BTS relative to the target transmitted power (PtxTarget);

for NRT users: rate of rejected capacity requests in UL & DL;

Orthogonal code shortage.

In 2.5 GHz operation, UL load may only be balanced by inter-frequency and inter-system handovers whereas DL load may be balanced in addition by inter-band handovers. So, when considering inter-band handovers (UL stays the same) only DL triggers may be important.

Therefore, FIG. 6 shows that in 2.5 GHz edge cells, both intra-frequency measurements for soft handover and continuous inter-frequency measurement (CM) may be needed. One way to guarantee avoidance of UL interference in a 2 GHz SHO area is to continuously monitor the 2 GHz DL CPICH Ec/Io in the cells where needed, (i.e., in coverage edge cells), and if a SHO area in the 2 GHz band is detected initiate an inter-band handover.

In contrast, an inter-band handover core band-to-2.5 GHz band may not occur in cells underlying a 2.5 GHz coverage edge cell if the UE is in a SHO area. Specifically, a load/service reason inter-band handover during SHO in core bands may not be allowed. Also, inter-band handover 2 GHz-to-2.5 GHz due to an unsuccessful soft handover (branch addition) procedure may be disabled, but inter-frequency allowed.

Compressed mode may also be used for avoidance of adjacent channel protection (ACP)-caused UL interference. ACP caused UL interference may occur at certain UE Tx power levels where the UE location is close to an adjacent band base station. This is mostly a macro-micro base station scenario. The interfered base station may be protected in DL if it is operating in the adjacent 2.5 GHz carrier otherwise not.

ACI probability may directly relates to the mobile's transmission power. Below certain powers the mobile cannot interfere to the micro base station and interference detection may not be required. A reasonable value for the power threshold that determines when to start interference detection may need to take into account the statistical probability of MCL (minimum coupling loss) situations, adjacent channel leakage ratio (ACLR), micro BTS noise level and desensitization. If the power is around the average UE Tx power (=−10 . . . 10 dBm) or higher, the number of mobiles continuously checking for ACI interference may be reduced significantly.

An interfered base station may not be able to protect itself from ACI interference. The interfering mobile device must voluntarily stop transmission on its current band. Only by also operating in the 2.5 GHz band is the interfered base station self-protected.

Regarding compressed mode operation in 2.5 Ghz band (Cell_DCH), when the UE is operating in the 2.5 GHz band and needs to measure the 2 GHz core DL bands, CM usage in the core band can be applied normally and balancing of UL load may be triggering separately inter-frequency measurements. As described previously, there may be several reasons for inter-band CM measurements when the UE is in the 2.5 GHz band.

Since the DL load of the other band may be known, the RNC may initiate instead of an inter-band handover directly, an inter-frequency or inter-system handover in case of high load. Then, separate inter-frequency/inter-system measurements may be performed. In order to minimize the effects on network performance, CM may need to be used very efficiently and one consistent CM usage strategy may need to cover all inter-band measurements. The most excessive CM usage may come from “ACI detection” and “SHO area detection”. Both of these may be continuous in case they are needed. Both may be largely avoided either by intelligent carrier allocation in the 2.5 GHz band or by network planning.

Most of the carriers are protected by carrier allocation. Only if an existing operator is not interested in 2.5 GHz deployment, the UL adjacent carriers may need the ACI detection to protect another carrier from UL interference. Also, if operators want to have different numbers of 2.5 GHz carriers, at some point, the UL carrier pattern may not be repeatable anymore in the 2.5 GHz band. Further, since a first operator may not use its additional carriers in the same geographical area and starting at the very same time as a second operator, ACI detection may be needed wherever protection from the 2.5 adjacent carrier is not provided.

UL carriers in the TDD band may be automatically protected because here the UL carrier may exist only if also 2.5 GHz band is deployed. However, the adjacencies between TDD band and UL band may need special attention as again a first UL carrier can be interfered by a second if it is not (yet) operating in the 2.5 GHz band.

Regarding SHO area detection, network planning can reduce the need of CM by limiting the number of 2.5 GHz coverage edge cells and indicating edge cells via RNP parameters. If sectorized cells in the core band are fully repeated in the upper band, i.e., no softer handover area in the UL that is not a softer handover area in the 2.5 GHz band, the detection of SHO areas may be made dependent on the UE transmission power or CPICH Ec/Io. However here, it is more difficult to determine a threshold since there is no general limitation how close base stations can be to each other. If almost complete 2.5 GHz coverage is needed it might be wise not to save on single sites and rather make the coverage as complete as possible. Moreover, if sparse capacity extension is needed, one can consider having less coverage area in the 2.5 GHz cell by lowering the CPICH pilot power or applying different coverage handover thresholds. This lowers the average UE transmission power in the sparse cell and thus the probability of ACI or unwanted entering in UL SHO area.

Non-regarding network planning, there are still some cells where all reasons for CM are given. Here, the CM usage must be made efficient.

Most all reasons for CM require measurement of the associated DL core band, either own cell or neighbors. ACI detection can also be obtained by measuring the RSSI of the adjacent carriers in the core. If both SHO area detection and ACI detection is needed, it may be more efficient to rely for both on Ec/Io measurements provided that latter measurement can be done quickly enough. This may be enabled for two reasons: (1) CM in 2.5 GHz band operation can use the fact that 2.5 GHz DL and 2 GHz DL are chip synchronized (assuming they are in the same base station cabinet), and (2) both DL bands have the same or at least very similar propagation path differing merely in stronger attenuation for the 2.5 GHz band.

Two options for chip energy/system noise (Ec/Io) measurements may include: (1) measure core band Ec/Io (fast due to chip synchronization)—more accurate, may require a measurement gap of 4-5 timeslots, and (2) measure core band RSSI and use CPICH Ec correlation between bands =>Ec/Io—may require a measurement gap of 1-2 timeslots.

The second option may be preferred due to the short gaps. Basically, not even level measurements (Ec/Io) are required if the relative difference between both DLs RSSI is considered. Uncertainties on the network side (antenna pattern/gain, cable loss, loading, PA rating, propagation loss/diffraction) as well as on the UE side (measurement accuracy) may disturb the comparison and may need to be taken into account if possible.

If a high difference in RSSIs (or low Ec/Io in the core band) is detected, the reason may be verified by:

measure associated core cell's neighbors→if SHO area (little i) make inter-band handover;

measure adjacent channel RSSI→if ACI make inter-frequency HO;

none of above true→no action required (associated core cell's load might be high).

In case (a), handover happens directly to a SHO area. This may require a fast enough branch addition after the inter-band hard handover.

Additionally, CM usage can be minimized by triggering it with some kind of UE speed estimate. If a UE is not moving CM can be ceased, when it moves again CM continues.

Regarding measurements for cell re-selection when the 2.5 GHz band is used, the UE in idle mode camps in the 2.5 GHz band as long as Ec/Io signal is good enough. In connected mode, PS services move to Cell_FACH, UTRAN registration area routing area paging channel (URA_PCH), or Cell_PCH state after a certain time of inactivity (NRT). Then, idle mode parameters may control the cell re-selection. Cell re-selection may then happen for a coverage reason, i.e., when the 2.5 GHz coverage ends.

Interference detection may need to be provided also in states controlled by idle mode parameters to prevent UL interference due to RACH transmission. Here, for ACI and SHO area detection different mechanisms may be applied.

SHO area detection in idle mode (and Cell_PCH, URA_PCH) may be enabled by a two-step measurement and applied to the coverage edge cells: (1) a cell specific absolute Ec/Io-threshold triggers step, and (2) measure core band whether there is a cell without inter-band neighbor in 2.5 GHz. To make the comparison, the UE may need to know the co-sited core neighbors. This may need to be added in 2.5 GHz broadcast channel system information (BCCH SI). In Cell_FACH state, SHO areas may be detected by using the IF measurements occasions and checking if found neighbors in the core band have a co-sited neighbor in the 2.5 GHz band. Again additional BCCH information may be needed.

FIG. 7 shows a diagram of mobile node measurement activities during different mobile node states according to an example embodiment of the present invention. The different states of the mobile device are shown inside arrows at the top of the figure. The mobile device may be in idle state, cell FACH state, or cell DCH state. The timeline shown in FIG. 7 is divided in half where the top half represents measurements to detect soft handover (SHO) area, and the bottom half represents measurements to detect adjacent channel interference (ACI). The various measurements that occur for each area and during each state of the mobile device along the time line are shown inside the bubbles.

ACI may not be detected in idle mode but immediately before RACH transmission by measuring directly the two adjacent carriers in the core band. The delay in RACH transmission may be negligible due to the fast RSSI measurements. In Cell_FACH state, ACI detection may be provided by continuously measuring the adjacent core carriers (stealing slots for RSSI measurements).

In the case of the SHO area, the UE may initiate an inter-band handover to the core band. In case ACI is detected, the UE may initiate an inter-frequency handover (UL changes) similar to a conventional coverage reason cell re-selection.

Methods and apparatus for selection of downlink carriers according to the present invention are advantageous for many reasons: efficient utilization of the additional 2.5 GHz spectrum for increased DL traffic, efficient utilization of spectrum designated for TDD1/2 for carrying additional UL traffic (to be paired with 2.5 GHz DL carriers), flexible range of achievable DL-UL traffic asymmetry, limited by the available spectrum (1:4 ratio) only, no or minimum restrictions in the utilization of all features and services of the 3GPP UTRA standard within the R4-R6 framework, minimum change impact on the 3GPP UTRA standard, implementation of the 2.5 GHz DL mode in UE and Radio Access Network (RAN) with minimum changes to current UMTS core band products, easy evolution of operational core band RANs and operational/RNP practices when adding the 2.5 GHz based DL carriers, easy evolution of operational core band RANs and operational/RNP practices when adding the 2.5 GHz based DL carriers, and a credible UTRA FDD concept supporting a wide and flexible range of achievable UL-DL traffic asymmetry and with the option of utilizing the TDD1/2 bands, will provide the industry a viable alternative to TDD-(LCR/HCR) based solutions in these bands.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for selection of downlink carriers in a cellular system comprising:
selecting a first downlink carrier for use by a mobile node;
deciding that the mobile node should use another downlink carrier;
directing the mobile node to use a second downlink carrier, the directing being from a network node; and
using the second downlink carrier by the mobile node.

2. The method according to claim 1, further comprising selecting the first downlink carrier from a first cell and selecting the second downlink carrier from a second cell.

3. The method according to clam 2, wherein the first cell includes downlink carriers in a core band and the second cell includes downlink carriers in an extension band.

4. The method according to clam 3, wherein the first cell comprises a cell with downlink carrier frequencies of at least approximately 2.0 GHz and the second cell comprises a cell with downlink carrier frequencies of at least approximately 2.5 GHz.

5. The method according to claim 1, further comprising selecting the first downlink carrier and the second downlink carrier from the same cell.

6. The method according to claim 1, further comprising directing the mobile node to use the second downlink carrier during establishment of a connection by the mobile node to the network.

7. The method according to claim 6, wherein the connection comprises a Radio Resource Control (RRC) connection.

8. The method according to claim 1, further comprising directing the mobile node to use the second downlink carrier during a mobile node state and when the mobile node requests establishment of a Data Channel (DCH) connection by the mobile node to the network.

9. The method according to claim 8, wherein the mobile node state comprises a Forward Access Channel (FACH) state.

10. The method according to claim 1, further comprising directing the mobile node to use the second downlink carrier during a mobile node state and when the mobile node is selecting a cell.

11. The method according to claim 10, wherein the mobile node state comprises one of a power-on state and an idle mode cell reselection state.

12. The method according to claim 1, further comprising deciding by the network node that the mobile node should use another downlink carrier based on current load conditions of the first downlink carrier and the second downlink carrier.

13. The method according to claim 12, further comprising deciding by the network node that the mobile node should use another downlink carrier based on the load condition of the first downlink carrier exceeding a defined threshold level and the load condition of the second downlink carrier being below the load condition of the first downlink carrier.

14. The method according to claim 12, further comprising deciding by the network node that the mobile node should use another downlink carrier based on a load condition caused by connections requiring real-time quality of service of the first downlink carrier exceeding a defined threshold level.

15. The method according to claim 12, further comprising deciding by the network node that the mobile node should use another downlink carrier based on a load condition caused by connections requiring non real-time quality of service of the first downlink carrier exceeding a defined level.

16. The method according to claim 1, further comprising deciding by the network node that the mobile node should use another downlink carrier based on a type of service on the first downlink carrier.

17. The method according to claim 1, further comprising deciding by the network node that the mobile node should use another downlink carrier based on whether the mobile node has cell connection capability at frequencies of the second downlink carrier.

18. The method according to claim 1, further comprising deciding by the network node that the mobile node should use another downlink carrier based on a potential interference condition.

19. The method according to claim 18, wherein the potential interference condition comprises uplink carrier interference.

20. The method according to claim 19, wherein the uplink carrier interference arises from the second downlink carrier being missing in a location that the mobile node is moving towards.

21. The method according to claim 19, wherein the uplink carrier interference arises from adjacent channel interference.

22. The method according to claim 1, wherein the network node comprises one of a Radio Network Controller (RNC) and a Base Station Controller (BSC).

23. A network node containing instructions stored therein, the instructions when executed causing the network node to perform:
selecting a downlink carrier for use by a mobile node;
deciding that the mobile node should use another downlink carrier; and
directing the mobile node to use a second downlink carrier.

24. The network node according to claim 23, further performing selecting the first downlink carrier from a first cell and selecting the second downlink carrier from a second cell.

25. The method according to clam 24, wherein the first cell includes downlink carriers in a core band and the second cell includes downlink carriers in an extension band.

26. The method according to clam 25, wherein the first cell comprises a cell with downlink carrier frequencies of at least approximately 2.0 GHz and the second cell comprises a cell with downlink carrier frequencies of at least approximately 2.5 GHz.

27. The method according to claim 23, further comprising selecting the first downlink carrier and the second downlink carrier from the same cell.

28. The network node according to claim 23, further performing deciding that the mobile node should use another downlink carrier based on current load conditions of the first downlink carrier and the second downlink carrier.

29. The network node according to claim 28, further performing deciding that the mobile node should use another downlink carrier based on the load condition of the first downlink carrier exceeding a defined threshold level and the load condition of the second downlink carrier being below the load condition of the first downlink carrier.

30. The network node according to claim 28, further performing deciding that the mobile node should use another downlink carrier based on a real-time load condition of the first downlink carrier exceeding a defined threshold level.

31. The network node according to claim 28, further performing deciding that the mobile node should use another downlink carrier based on a non real-time load rejection condition of the first downlink carrier exceeding a defined level.

32. The network node according to claim 28, further performing deciding that the mobile node should use another downlink carrier based on a type of service on the first downlink carrier.

33. The network node according to claim 23, further performing deciding that the mobile node should use another downlink carrier based on whether the mobile node has connection capability at the frequency of the second downlink carrier.

34. The network node according to claim 23, further performing deciding that the mobile node should use another downlink carrier based on a potential interference condition.

35. The network node according to claim 34, wherein the potential interference condition comprises uplink carrier interference.

36. The network node according to claim 23, wherein the network node comprises one of a Radio Network Controller (RNC) and a Base Station Controller (BSC).
